(19) United States
(12) Patent Application Publication
(10) Pub. No.: US 2008/0126572 A1
(43) Pub. Date: May 29, 2008

(54) Multi-path switching networks

(76) Inventor: John M. Holt, Essex (GB)

Correspondence Address: PERKINS COIE LLP, P.O. BOX 2168, MENLO PARK, CA, 94026, US

(21) Appl. No.: 11/973,339

(22) Filed: Oct. 5, 2007

Related U.S. Application Data
(60) Provisional application No. 60/850,510, filed on Oct. 9, 2006.
(60) Provisional application No. 60/850,519, filed on Oct. 9, 2006.

(30) Foreign Application Priority Data
Oct. 5, 2006 (AU) 2006905503
Oct. 5, 2006 (AU) 2006905520

(51) Int. Cl. G06F 15/16

(52) U.S. Cl. 709/252

(57) ABSTRACT

A switching network for multiple computer systems is disclosed which utilises pairs of multi-port switches (S1-S4) and (preferably) less complex switches (S5-S7). The multi-port switches are arranged in pairs with a computer of the multiple computer system being able to be connected to each port of each multi-port switch except for one port. That one port of each multi-port switch is connected to a single one of the less complex switches. All the less complex switches are arranged in a twin branch multi-level tree structure. The arrangement overcomes bottlenecks arising from the serial interconnection of multi-port switches.

### CROSS REFERENCE TO RELATED APPLICATIONS

The present application claims the benefit of priority to U.S. Provisional Application Nos. 60/850,510 (5027CV-US)) and 60/850,519 (5027DA-US), both filed 9 Oct. 2006; and to Australian Provisional Application Nos. 2006905520 (5027CV-AU) and 2006905503 (5027DA-AU), both filed on 5 Oct. 2006, each of which are hereby incorporated herein by reference.

This application is related to concurrently filed U.S. Application entitled “Multi-Path Switching Networks,” (Attorney Docket No. 61130-8035.US02 (5027CV-US02)), which is hereby incorporated herein by reference.

### FIELD OF THE INVENTION

The present invention relates to switching networks for multiple computer systems. The present invention finds particular application in replicated shared memory (or hybrid or partial shared memory) computer systems but is not restricted thereto. The present invention also finds application in distributed shared memory multiple computer systems.

### BACKGROUND

For an explanation of a multiple computer system incorporating replicated shared memory, or hybrid replicated shared memory, reference is made to the present applicant's International Patent Application No. WO 2005/103926 Attorney Ref 5027F-WO (to which U.S. patent application Ser. No. 11/111,946 corresponds), and to International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, and to Australian Patent Application No. 2005 905 582 Attorney Ref 50271 (to which U.S. patent application Ser. No. 11/583,958 (60/730,543) and PCT/AU2006/001447 (WO2007/041762) correspond) and to Australian and US patent application Nos. 2006 905 534 and 60/850,537 both entitled “Hybrid Replicated Shared Memory Architecture” Attorney Ref 5027Y, all of which are hereby incorporated by cross-reference for all purposes.

Briefly stated, the abovementioned patent specifications disclose that at least one application program written to be operated on only a single computer can be simultaneously operated on a number of computers each with independent local memory. The memory locations required for the operation of that program are replicated in the independent local memory of each computer. On each occasion on which the application program writes new data to any replicated memory location, that new data is transmitted and stored at each corresponding memory location of each computer. Thus apart from the possibility of transmission delays, each computer has a local memory the contents of which are substantially identical to the local memory of each other computer and are updated to remain so. Since all application programs, in general, read data much more frequently than they cause new data to be written, the abovementioned arrangement enables very substantial advantages in computing speed to be achieved. In particular, the stratagem enables two or more commodity computers interconnected by a commodity communications network to be operated simultaneously running under the application program written to be executed on only a single computer.

Hitherto, as the number of computers in a multiple computer system (such as a multiple computer system operating as a replicated shared memory arrangement) increases, so the performance of the communication network interconnecting the computers degrades, often to the point where adding an additional computer or computers does not result in any substantial increase in the overall speed of the system.

### Genesis of the Invention

The genesis of the present invention is a desire to provide a switching network which, to some extent at least, reduces the abovementioned disadvantage.

### SUMMARY OF THE INVENTION

In accordance with the first aspect of the present invention there is disclosed a switching network for a multiple computer system, said network comprising a first plurality of multi-port switches and a second plurality of switches, said multi-port switches being arranged in pairs with a computer of said multiple computer system being connectable to each port of each multi-port switch except one port, said one port of each pair of multi-port switches being connected to a single one of said second plurality of switches, and all said second plurality of switches being arranged in a twin branch multi-level tree structure. Preferably the second plurality of switches are less complex switches than the multi-port switches.

In accordance with a second aspect of the present invention there is disclosed a method of providing a switching network for a multiple computer system, said method comprising the steps of:
(i) providing first plurality of multi-port switches and a second plurality of switches,
(ii) arranging said multi-port switches in pairs and connecting a computer of said multiple computer systems to each port of each multi-port switch except one port,
(iii) connecting said one port of each pair of multi-port switches to a single one of said second plurality of switches, and
(iv) arranging all said second plurality of switches in a twin branch multi-level tree structure.

In accordance with a third aspect of the present invention there is disclosed a switching network for a multiple computer system, each of the computers of which having an independent local memory and each operating a different portion of same application program written to operate on only a single computer, and where each said independent local memory comprises at least one application memory location replicated in all of said independent local memories and updated to remain substantially similar, said network comprising a first plurality of multi-port switches and a second plurality of switches, said multi-port switches being arranged in pairs with a computer of said multiple computer system being connectable to each port of each multi-port switch except one port, said one port of each pair of multi-port switches being connected to a single one of said second plurality of switches, and all said second plurality of switches being arranged in a twin branch multi-level tree structure. Preferably the second plurality of switches are less complex switches than the multi-port switches.

In accordance with a fourth aspect of the present invention there is disclosed a method of providing a switching network for a multiple computer system, each of the computers of which having an independent local memory and each operating a different portion of same application program written to operate on only a single computer, and where each said independent local memory comprises at least one application memory location replicated in all of said independent local memories and updated to remain substantially similar, said method comprising the steps of:
(i) providing first plurality of multi-port switches and a second plurality of switches,
(ii) arranging said multi-port switches in pairs and connecting a computer of said multiple computer systems to each port of each multi-port switch except one port,
(iii) connecting said one port of each pair of multi-port switches to a single one of said second plurality of switches, and
(iv) arranging all said second plurality of switches in a twin branch multi-level tree structure.

In accordance with a fifth aspect of the present invention there is disclosed a multiple computer system comprising a switching network providing communication between said multiple computers, each of said computers comprising an independent local memory and each operating a different portion of same application program written to operate on only a single computer, and where each said independent local memory comprises at least one application memory location replicated in all of said independent local memories and updated to remain substantially similar, said network comprising a first plurality of multi-port switches and a second plurality of switches, said multi-port switches being arranged in pairs with a computer of said multiple computer system being connectable to each port of each multi-port switch except one port, said one port of each pair of multi-port switches being connected to a single one of said second plurality of switches, and all said second plurality of switches being arranged in a twin branch multi-level tree structure. Preferably the second plurality of switches are less complex switches than the multi-port switches.

### BRIEF DESCRIPTION OF THE DRAWINGS

An embodiment of the present invention will now be described with reference to the drawings in which:

FIG. 1A is a schematic representation of an RSM multiple computer system,

FIG. 1B is a similar schematic representation of a partial or hybrid RSM multiple computer system,

FIG. 1 is a schematic representation of a prior art switching network for a multiple computer system utilising a single multi-port switch,

FIG. 2 is a similar representation of a prior art switching network incorporating two multi-port switches,

FIG. 3 illustrates the switching network of FIG. 2 having reached its maximum capacity,

FIG. 4 is a representation of a prior art switching network similar to FIGS. 2 and 3 but utilising three multi-port switches,

FIG. 5 is a representation of a prior art twin branch multi-level tree structure, and

FIG. 6 is a representation of a switching network in accordance with the preferred embodiment of the present invention utilising both multi-port switches and less complex switches.

### DETAILED DESCRIPTION

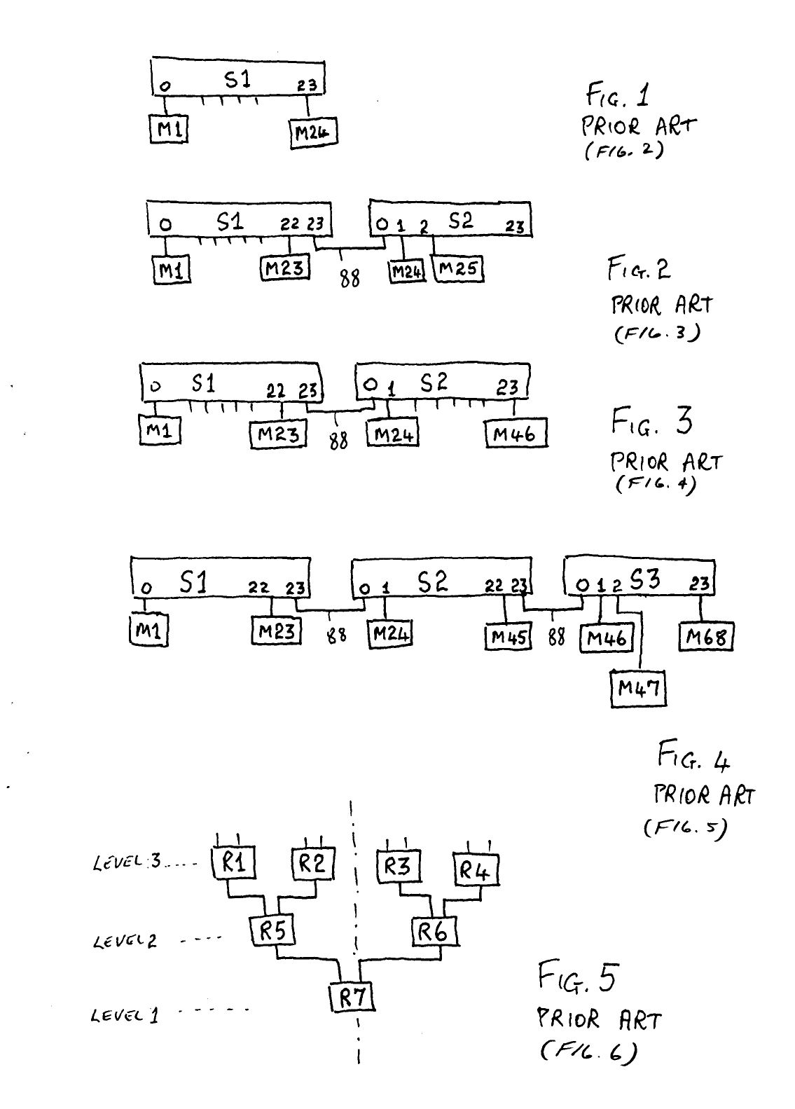

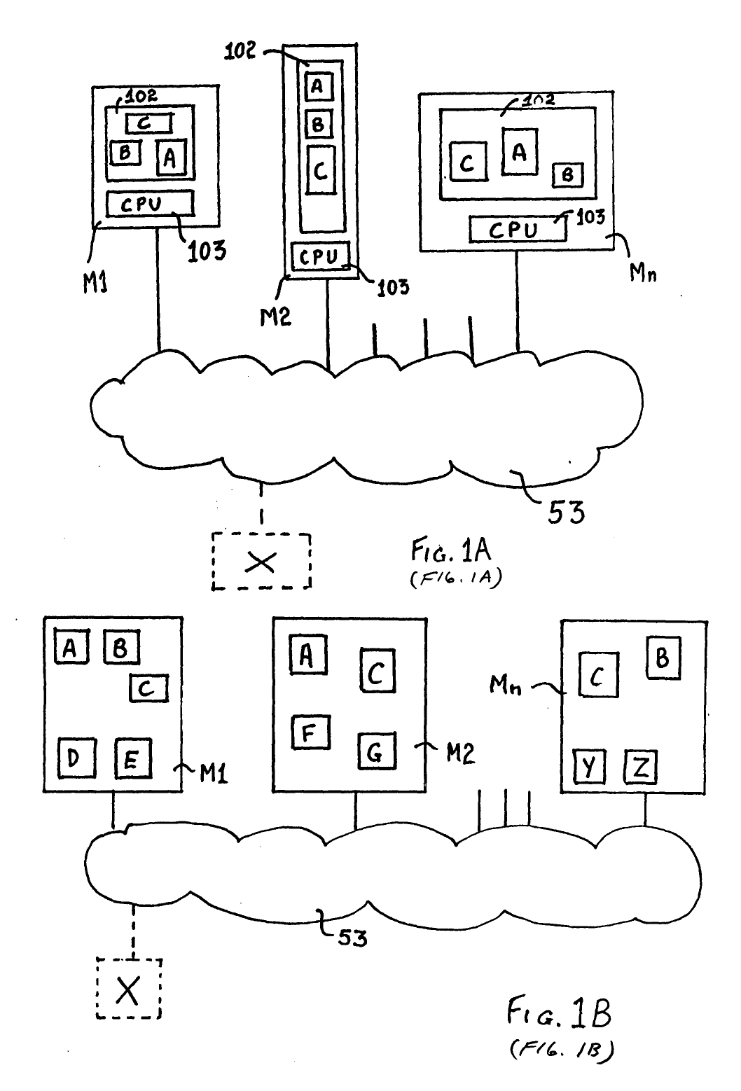

FIG. 1A is a schematic diagram of replicated shared memory system. In FIG. 1A three machines are shown, of a total of “n” machines (n being an integer greater than one) that is machines M1, M2, . . . Mn. Additionally, a communications network 53 is shown interconnecting the three machines and a preferable (but optional) server machine X which can also be provided and which is indicated by broken lines. In each of the individual machines, there exists a memory 102 and a CPU 103. In each memory 102 there exists three memory locations, a memory location A, a memory location B, and a memory location C. Each of these three memory locations is replicated in a memory 102 of each machine.

This arrangement of the replicated shared memory system allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2 . . . Mn which each have a local replica of memory location A. This result is achieved by detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 1B and termed partial or hybrid replicated shared memory (RSM). Here memory location A is replicated on computers or machines M1 and M2, memory location B is replicated on machines M1 and Mn, and memory location C is replicated on machines M1, M2 and Mn. However, the memory locations D and E are present only on machine M1, the memory locations F and G are present only on machine M2, and the memory locations Y and Z are present only on machine Mn. Such an arrangement is disclosed in Australian Patent Application No. 2005 905 582 Attorney Ref 50271 (to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread task or process is able to, at a later stage, propagate the changed value to the other machines which also replicate the written to memory location, such that subject to an update and propagation delay, the memory contents of the written to memory location on all of the machines on which a replica exists, are substantially identical. Various other alternative embodiments are also disclosed in the abovementioned specification.

Therefore, when operating a multiple computer system in a replicated shared memory arrangement where replicated memory locations are not necessarily replicated on all member machines (such as for example memory location “A” of FIG. 1B), it is desirable that replica memory update transmissions (such as replica memory update messages or packets) transmitted by a single source machine and destined for some subset of all receiving machines on which a corresponding replica memory location resides, is transmitted by the network 53 (comprising one or more switches interconnecting the plural machines) in such a manner that only the machines on which a corresponding replica memory location resides receive such transmission. Additionally, it is further desirable that a single replica memory update transmission is sent corresponding to a single change of a replica memory location of the transmitting machine, and that such single replica memory update transmission be transmitted by the network 53 (comprising the one or more switches interconnecting the plural machines) to multiple receiving machines on which a corresponding replica memory location resides, without duplicate or superfluous transmissions.

As seen in FIG. 1, where the number of computers or machines of the multiple computer network is relatively small, a single multi-port switch S1 can be utilised to provide the communications network which interconnects these individual computers. Thus, as seen in FIG. 1, a multi-port switch having 24 ports (numbered 0-23) is commercially available from equipment suppliers such as NETGEAR and CISCO both of the USA. The cost of a 24 port switch is approximately $US2,000-$3,000 as of the priority date. Multi-port switches having 48 ports are known but are very expensive.

As indicated in FIG. 2, if the number of the computers is to be increased to 25 then it is necessary for an additional switch S2 to be purchased and for the two switches S1 and S2 to be interconnected each using an individual port. In FIG. 2 the inter-connecting link 88 is connected to port 23 of switch S1 and port 0 of switch S2.

As indicated in FIG. 3, this arrangement is satisfactory up to 46 computers, however, if a 47^{th} computer is to be added then a third switch S3 is required as indicated in FIG. 4 and this arrangement is able to accommodate up to 68 computers.

Set out below in Table No. 1 is the maximum number of computers able to be inter-connected by the corresponding number of 24 port switches in the manner indicated in FIGS. 2-4 inclusive.

TABLE NO. 1

| No. of 24 Port Switches | Max. No. of Computers |
|---|---|
| 1 | 24 |
| 2 | 46 |
| 3 | 68 |
| 4 | 90 |
| 5 | 112 |
| 6 | 134 |
| 7 | 156 |
| 8 | 178 |
| 16 | 354 |

A fundamental problem with the above described prior art arrangement is that the inter-connecting links 88 constitute very substantial bottlenecks in the communications network. In particular, in the prior art there are two known types of messages which are transmitted between the individual computers M1-M68 of FIG. 4 for example. These are a broadcast message where a computer M1 sends a single message to all other computers. Often, the message sent by computer M1 is not intended to be sent to all other computers but is intended to be sent to only to some sub-set of the computers. In this instance, the broadcast message is addressed to the specific subset of computers and those computers which are not listed in the address of the broadcast message receive the broadcast message but ignore it. This is very wasteful of the available bandwidth. The alternative is a unicast message where, say, machine M1 sends a message addressed to, say, M46 in which case the message has to pass through both of the interconnecting links 88. Again, where machine M1 wishes to communicate with some subset of the machines, then it is possible to send consecutive unicast messages each of which is individually addressed to the corresponding machine.

Turning now to FIG. 5, it is also known in the electrical engineering world to provide a tree structure such as illustrated in FIG. 5. For example, such tree structures are known to interconnect relays such as the seven relays R1-R7 illustrated in FIG. 5. The arrangement is reminiscent of the trunk and branches of a tree and the relay R7 is said to constitute the lowest level, the relays R5 and R6 constitute the second level, and the relays R1-R4 constitute the highest or third level. With double pole single throw relays it is possible to connect any one of the contacts of the highest level relays R1-R4 with each other.

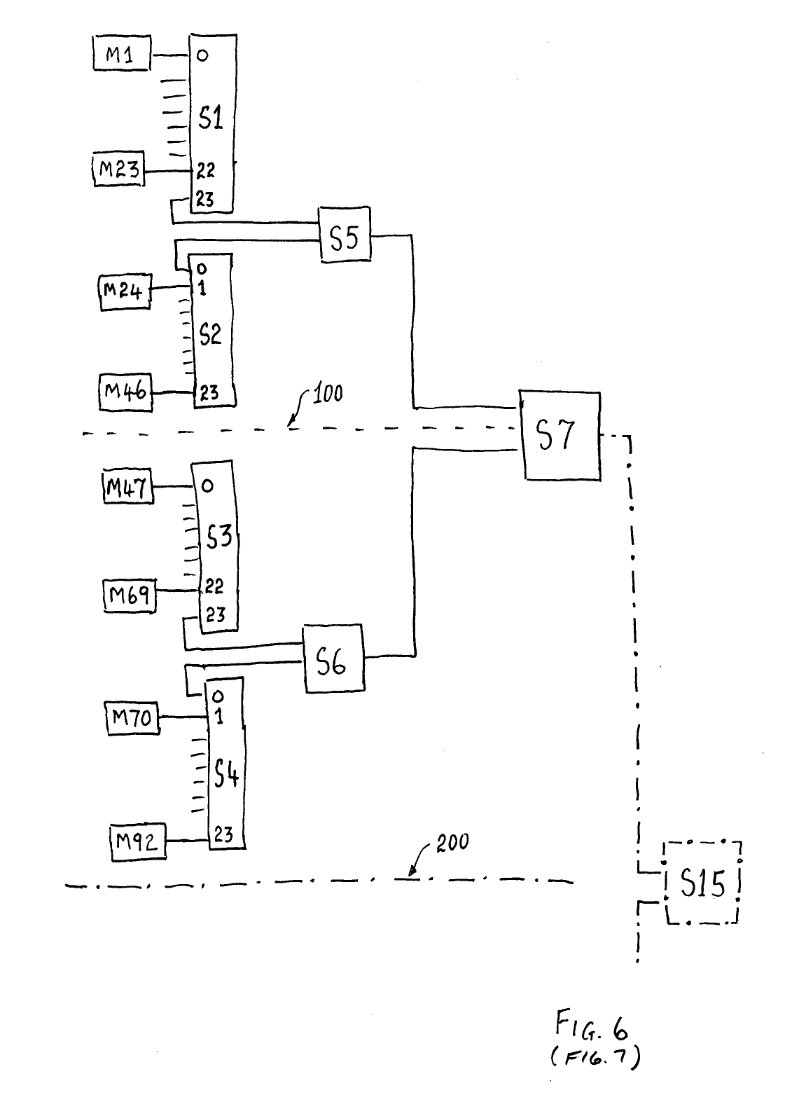

Turning now to FIG. 6, the preferred embodiment of the switching network of the present invention is illustrated and incorporates elements of the prior art of FIG. 5 in combination with multi-port switches. In particular, in FIG. 6 there are four multi-port switches S1-S4 each of which has 24 ports (numbered 0-23). Port 23 of switch S1 and port 0 of switch S2, instead of being directly connected together as in FIGS. 2-4, are instead connected to two ports of a three port switch S5. The switch S5 is preferably less complex than the multi-port switch 21 and as of the priority date costs approximately $US150-300. Computers M1-M23 of the multiple computer system are connected to ports 0-22 of switch S1 and computers M24-M46 of the multiple computer system are connected to ports 1-23 of switch S2.

The pair of multi-port switches formed by switches S1 and S2 is duplicated for switches S3 and S4 with three port switch S6 being located in the equivalent position to switch S5. Computers M47-M69 are connected to ports 0-22 of switch S3 and computers M70-M92 are connected to ports 1-23 of switch S4. Finally, switches S5 and S6 are connected to switch S7 which can therefore be a dual port switch rather than a three port switch.

The arrangement thus far described in relation to FIG. 6 is symmetrical about the broken line 100 of FIG. 6 and the switch S7 represents the lowest level or level 1 of a two level twin branch tree structure.

As indicated by dot-dash lines in FIG. 6, the arrangement thus far described in relation to FIG. 6 can be duplicated in a form which is symmetrical about the dot-dash line 200 of FIG. 6. In such an arrangement, there are eight 24 port switches and seven (preferably) less complex switches. In a similar manner, not illustrated, that entire arrangement is able to be duplicated again, and so on. Utilising eight 24 port switches the maximum number of computers able to be interconnected is 184 (being twice the 92 computers illustrated in FIG. 6). Set out below in Table 2 is the maximum number of computers able to be interconnected given the number of 24 port switches and the number of less complex switches set out in Table 2.

TABLE NO. 2

| No. of 24 Port | No. of Less Complex | Max. No. of |
|---|---|---|
| Switches | Switches | Computers |
| 2 | 1 | 46 |
| 4 | 3 | 92 |
| 8 | 7 | 184 |
| 16 | 15 | 368 |

Given that the price of the 24 port switches is very much greater than the less complex switches, it will be seen that the topology of FIG. 6 provides a numerical advantage over the topology of FIGS. 2-4.

However, the most substantial advantage which arises from the arrangement of FIG. 6, has to do with overcoming the bottleneck formed by the interconnecting links 88 of FIGS. 2-4. In particular, if a computer such as M1, which is connected to switch S1, wishes to send a message to a computer which is connected to switch S2, then this message is routed by switch S5 directly to switch S2. Conversely, if a computer such as M1, which is connected to switch S1 wishes to send a message to computer connected to switch S4, then this message is routed by switches S5, S7 and S6 to switch S4. As a consequence, such a message does not have to travel through switches S2 and S3 which would be the case with the arrangement of FIG. 4 (as extended for four switches). As a consequence, the bottlenecks formed by the interconnecting links 88 are bypassed by the multi-level tree structure.

In a co-pending application, entitled “Switch Protocol for Network Communication” and allocated Australian provisional patent application No. 2006 905 503 which corresponds to U.S. patent application No. 60/850,519 (Attorney Reference 5027DA) a system of addressing addressed data packages in a network is disclosed. The contents of those specifications are hereby incorporated into the present application for all purposes.

Briefly stated, in these specifications there is disclosed a switch arrangement for transmission of addressed data packets in a communications network including one or more switches each having a plurality of ports and a plurality of computers each of which is connected to at least one switch via at least one port and each of which can send or receive the data packets. The arrangement takes the form of a memory in each switch listing for each port those computers able to be accessed via that port.

There is disclosed a communications method in which data packets addressed to multiple destinations are transmitted via at least one multi-port switch from a source. The method takes the form of the steps of:

(i) providing the or each switch with a data processing capacity,

(ii) having each switch on receipt of one of the data packets delete those addresses of said multiple destinations which are inaccessible thereby.

Thus these specifications disclose a switch protocol for network communications (particularly but not exclusively for multiple computer systems) in which each switch (S1, S2, S3) maintains a list of addresses which can be reached via each port (A,B,C) of the switch. In addition, prior to delivering a message or packet to a port, the switch deletes any address in the message or packet which is unable to be reached via that port. The arrangement saves the repetitive sending of uni-cast messages and also saves broadcast messages being sent via the switches to computers which are not intended to receive the messages. Various networked topologies are also disclosed.

In the event that the abovementioned addressing system is utilised, then very substantial advantages are gained from the switching network of the present invention since the deletion of addresses which can be delivered directly by a network switch, from the message being passed on by one network switch to another, very substantially reduces the volume of communication on the communications network.

Finally, in one specific arrangement of FIG. 6, the indicated computers M1 . . . M92 are operating together as a replicated shared memory arrangement, and utilising the above described switch arrangement (and optionally also utilising the above mentioned protocol) for replica memory update transmissions between the plural computers. Specifically, in such specific arrangements, each computer is operating a different portion of a same application program written to operate on only a single computer, each computer (machine) of which comprises an independent local memory with at least one application memory location replicated in the independent local memory of at least two machines and updated to remain substantially similar, and utilising the above described switch (and optionally protocol) arrangement for single-sent replica memory update transmissions (for example single-sent replica memory update messages or packets comprising changes made by the transmitting machine to a replicated memory location) sent by each computer (machine) and addressed to multiple receiving computers (machines) on which a corresponding replica memory location resides, each such single-sent transmission being received once by each of the addressed plural computers (machines) and not received by any non-addressed computers (machines). Preferably, the computer (machine) addresses used for each such single-sent replica memory update transmission, are the per-machine hierarchical addresses allocated by a server computer (machine) X (or the switch(s) themselves) for each computer described above, and known to the single or plural switches.

In alternative multicomputer arrangements, such as distributed shared memory arrangements and more general distributed computing arrangements, the above described methods may still be applicable, advantageous, and used. Specifically, any multi-computer arrangement where replica, “replica-like”, duplicate, mirror, cached or copied memory locations exist, such as any multiple computer arrangement where memory locations (singular or plural), objects, classes, libraries, packages etc are resident on a plurality of connected machines and preferably updated to remain consistent, then the methods are applicable. For example, distributed computing arrangements of a plurality of machines (such as distributed shared memory arrangements) with cached memory locations resident on two or more machines and optionally updated to remain consistent comprise a functional “replicated memory system” with regard to such cached memory locations, and is to be included within the scope of the present invention. Thus, it is to be understood that the aforementioned methods apply to such alternative multiple computer arrangements. The above disclosed methods may be applied in such “functional replicated memory systems” (such as distributed shared memory systems with caches) mutatis mutandis.

It is also provided and envisaged that any of the described functions or operations described as being performed by an optional server machine X (or multiple optional server machines) may instead be performed by any one or more than one of the other participating machines of the plurality (such as machines M1, M2, M3 . . . Mn of FIG. 1A).

Alternatively or in combination, it is also further provided and envisaged that any of the described functions or operations described as being performed by an optional server machine X (or multiple optional server machines) may instead be partially performed by (for example broken up amongst) any one or more of the other participating machines of the plurality, such that the plurality of machines taken together accomplish the described functions or operations described as being performed by an optional machine X. For example, the described functions or operations described as being performed by an optional server machine X may broken up amongst one or more of the participating machines of the plurality.

Further alternatively or in combination, it is also further provided and envisaged that any of the described functions or operations described as being performed by an optional server machine X (or multiple optional server machines) may instead be performed or accomplished by a combination of an optional server machine X (or multiple optional server machines) and any one or more of the other participating machines of the plurality (such as machines M1, M2, M3 . . . Mn), such that the plurality of machines and optional server machines taken together accomplish the described functions or operations described as being performed by an optional single machine X. For example, the described functions or operations described as being performed by an optional server machine X may broken up amongst one or more of an optional server machine X and one or more of the participating machines of the plurality.

Any and all embodiments of the present invention are to take numerous forms and implementations, including in software implementations, hardware implementations, silicon implementations, firmware implementation, or software/hardware/silicon/firmware combination implementations.

Various methods and/or means are described relative to embodiments of the present invention. In at least one embodiment of the invention, any one or each of these various means may be implemented by computer program code statements or instructions (possibly including by a plurality of computer program code statements or instructions) that execute within computer logic circuits, processors, ASICs, microprocessors, microcontrollers, or other logic to modify the operation of such logic or circuits to accomplish the recited operation or function. In another embodiment, any one or each of these various means may be implemented in firmware and in other embodiments such may be implemented in hardware. Furthermore, in at least one embodiment of the invention, any one or each of these various means may be implemented by a combination of computer program software, firmware, and/or hardware.

Any and each of the aforedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer on which it executes or on a computer coupled with, connected to, or otherwise in signal communications with the computer on which the computer program or computer program product is present or executing. Such computer program or computer program product modifying the operation and architectural structure of the computer, computing machine, and/or information appliance to alter the technical operation of the computer and realize the technical effects described herein.

To summarize, there is disclosed a switching network for a multiple computer system, the network comprising a first plurality of multi-port switches and a second plurality of switches, the multi-port switches being arranged in pairs with a computer of the multiple computer system being connectable to each port of each multi-port switch except one port, the one port of each pair of multi-port switches being connected to a single one of the second plurality of switches, and all the second plurality of switches being arranged in a twin branch multi-level tree structure.

Preferably each of the second plurality of switches is a less complex switch than the multi-port switches.

Preferably the pairs of multi-port switches are symmetrically arranged with respect to the less complex switch of the lowest level of the tree structure.

Preferably the less complex switch of the lowest level of the tree structure comprises a two port switch and all the other of the less complex switches comprise three port switches.

Also there is disclosed a method of providing a switching network for a multiple computer system, the method comprising the steps of:
(i) providing first plurality of multi-port switches and a second plurality of switches,
(ii) arranging the multi-port switches in pairs and connecting a computer of the multiple computer systems to each port of each multi-port switch except one port,
(iii) connecting the one port of each pair of multi-port switches to a single one of the second plurality of switches, and
(iv) arranging all the second plurality of switches in a twin branch multi-level tree structure.

Preferably there is a method included the further steps of:
(v) selecting each of the second plurality of switches to be a less complex switch than the multi-port switches.

Preferably there is a method including the further step of:
(vi) arranging the pairs of multi-port switches symmetrically with respect to the less complex switch of the lowest level of the tree structure.

Preferably there is a method including the further steps of:
(vii) selecting the less complex switch of the lowest level of the tree structure to be a two port switch, and
(viii) selecting all other of the less complex switches to be three port switches.

Furthermore, there is disclosed a switching network for a multiple computer system, each of the computers of which having an independent local memory and each operating a different portion of same application program written to operate on only a single computer, and where each said independent local memory comprises at least one application memory location replicated in all of said independent local memories and updated to remain substantially similar, said network comprising a first plurality of multi-port switches and a second plurality of switches, said multi-port switches being arranged in pairs with a computer of said multiple computer system being connectable to each port of each multi-port switch except one port, said one port of each pair of multi-port switches being connected to a single one of said second plurality of switches, and all said second plurality of switches being arranged in a twin branch multi-level tree structure.

Preferably the second plurality of switches are less complex switches than the multi-port switches.

Still further there is disclosed a method of providing a switching network for a multiple computer system, each of the computers of which having an independent local memory and each operating a different portion of same application program written to operate on only a single computer, and where each said independent local memory comprises at least one application memory location replicated in all of said independent local memories and updated to remain substantially similar, said method comprising the steps of:
(i) providing first plurality of multi-port switches and a second plurality of switches,
(ii) arranging said multi-port switches in pairs and connecting a computer of said multiple computer systems to each port of each multi-port switch except one port,
(iii) connecting said one port of each pair of multi-port switches to a single one of said second plurality of switches, and
(iv) arranging all said second plurality of switches in a twin branch multi-level tree structure.

Further still there is disclosed a multiple computer system comprising a switching network providing communication between said multiple computers, each of said computers comprising an independent local memory and each operating a different portion of same application program written to operate on only a single computer, and where each said independent local memory comprises at least one application memory location replicated in all of said independent local memories and updated to remain substantially similar, said network comprising a first plurality of multi-port switches and a second plurality of switches, said multi-port switches being arranged in pairs with a computer of said multiple computer system being connectable to each port of each multi-port switch except one port, said one port of each pair of multi-port switches being connected to a single one of said second plurality of switches, and all said second plurality of switches being arranged in a twin branch multi-level tree structure.

Preferably the second plurality of switches are less complex switches than the multi-port switches.

The foregoing describes only some embodiments of the present invention and modifications, obvious to those skilled in the electrical engineering arts, can be made thereto without departing from the scope of the present invention.

The term “comprising” (and its grammatical variations) as used herein is used in the inclusive sense of “including” or “having” and not in the exclusive sense of “consisting only of”.

1. A switching network for a multiple computer system, said switching network comprising:
a first plurality of multi-port switches and a second plurality of switches;
said multi-port switches being arranged in pairs with a computer of said multiple computer system being connectable to each port of each multi-port switch except one port;
said one port of each pair of multi-port switches being connected to a single one of said second plurality of switches; and
all said second plurality of switches being arranged in a twin branch multi-level tree structure.

2. The network as in claim 1, wherein each of said second plurality of switches is a less complex switch than said multi-port switches.

3. The network as in claim 2, wherein said pairs of multi-port switches are symmetrically arranged with respect to the less complex switch of the lowest level of said tree structure.

4. The network as in claim 3, wherein said less complex switch of the lowest level of said tree structure comprises a two port switch and all the other of said less complex switches comprise three port switches.

5. The network as in claim 3, wherein the interconnection on multi-port and other switches in different from a serial interconnection of multi-port switches.

6. A method of connecting and operating a switching network for a multiple computer system that includes a plurality of computers, said method comprising:
providing or enabling for operation a first plurality of multi-port switches and a second plurality of switches, each multi-port switch including a plurality of ports;
arranging said first plurality of multi-port switches and said second plurality of switches in pairs with a computer of said plurality of computers being at least intermittently connected to each port of each multi-port switch except one differently connected port;
said one differently connected port of each pair of multi-port switches being connected to a single one of said second plurality of switches; and
all said second plurality of switches being arranged in a twin branch multi-level tree structure.

7. The method as in claim 6, wherein each of said second plurality of switches is a less complex switch than said multi-port switches.

8. The method as in claim 7, wherein said pairs of multi-port switches are symmetrically arranged with respect to the less complex switch of the lowest level of said tree structure.

9. The method as in claim 8, wherein said less complex switch of the lowest level of said tree structure comprises a two port switch and all the other of said less complex switches comprise three port switches.

10. A computer program stored in a computer readable media, the computer program including executable computer program instructions and adapted for execution in a processor within a computer or information appliance for modifying the operation of the computer or information appliance; the modification of operation including performing a method of operating a switching network for a multiple computer system that includes a plurality of computers, said method comprising:
enabling for operation a first plurality of multi-port switches and a second plurality of switches, each multi-port switch including a plurality of ports;
coupling for communication said first plurality of multi-port switches and said second plurality of switches in pairs and a computer of said plurality of computers being at least intermittently connected to each port of each multi-port switch except one differently connected port;
said one differently connected port of each pair of multi-port switches being coupled for communication to a single one of said second plurality of switches; and
all said second plurality of switches being configured to operate in a twin branch multi-level tree structure.
